(19) United States
(12) Patent Application Publication
(10) Pub. No.: US 2013/0038161 A1
(43) Pub. Date: Feb. 14, 2013

(54) PERMANENT MAGNET ROTOR

(71) Applicant: Mingpan PAN, Zhongshan (CN)

(72) Inventor: Mingpan PAN, Zhongshan (CN)

(73) Assignee: Zhongshan Broad-Ocean Motor Manufacturing Co., Ltd., Zhongshan (CN)

(21) Appl. No.: 13/292,054

(22) Filed: Nov. 8, 2011

(30) Foreign Application Priority Data
Aug. 11, 2011 (CN) 201120290991.3

(51) Int. Cl. H02K 1/27

(52) U.S. Cl. 310/156.01

(57) ABSTRACT

A permanent magnet rotor for a motor, the permanent magnet rotor including an iron core and a permanent magnet. The iron core includes an annular ring having a central axial bore and a plurality of magnetic induction blocks protruding outwards from an outer side of the annular ring. Between two adjacent magnetic induction blocks form a radial recess for mounting the permanent magnets. The magnetic induction blocks at both sides of an opening of the radial recess protrude with a hook block. The section of an outer side surface of the magnetic induction blocks is a circular-arc line and the outer side surface employs a point with a distance deviating from the center of the central axial bore as a center of circle. The permanent magnet rotor has a simple structure, low magnetic leakage and torque ripple, big counter-electromotive force constant, and smooth waveform of counter-electromotive force.

### CROSS-REFERENCE TO RELATED APPLICATIONS

Pursuant to 35 U.S.C. § 119 and the Paris Convention Treaty, this application claims the benefit of Chinese Patent Application No. 201120290991.3, filed Aug. 11, 2011, the contents of which are incorporated herein by reference.

### BACKGROUND OF THE INVENTION

1. Field of the Invention

The invention relates to a permanent magnet rotor of a motor.

2. Description of the Related Art

As shown in FIG. 1, a conventional permanent magnet rotor of a motor includes an annular ring 2 having a central axial bore 1 and a plurality of magnetic induction blocks 3 protruding outwards from an outer side of the annular ring 2. Between two adjacent magnetic induction blocks 3 form a recess 4 for mounting the permanent magnets 3. The magnetic induction blocks 3 at both sides of an opening of the recess 4 protrude with a hook block 31. An outer contour of the magnetic induction blocks 3 is formed by a circular-arc line 33 and the circular-arc line 33 employs the center of the central axial bore 1 as a center of circle. Such structure has the disadvantage of large magnetic leakage of the rotor core, high torque ripple, and distorted top waveform of counter-electromotive force.

### SUMMARY OF THE INVENTION

In view of the above-described problems, it is one objective of the invention to provide a permanent magnet rotor of a motor that has a simple structure, low magnetic leakage and torque ripple, big counter-electromotive force constant, smooth waveform of counter-electromotive force, high service performance, and low loss.

To achieve the above objective, in accordance with one embodiment of the invention, there provided is a permanent magnet rotor of a motor comprising an iron core and a permanent magnet, wherein the iron core comprises an annular ring having a central axial bore and a plurality of magnetic induction blocks protruding outwards from an outer side of the annular ring; between two adjacent magnetic induction blocks form a radial recess for mounting the permanent magnets; the magnetic induction blocks at both sides of an opening of the radial recess protrude with a hook block; the section of an outer side surface of the magnetic induction blocks is an circular-arc line and the outer side surface employs a point with a distance deviating from the center of the central axial bore as a center of circle.

In a class of this embodiment, the distance deviating from the center of the central axial bore is 5-20 mm.

In a class of this embodiment, the maximum external diameter of the iron core is 80-90 mm and the number of the magnetic induction blocks is 10.

In a class of this embodiment, a distance between the two hook blocks arranged at the opening of the same radial recess is 3.5-5 mm.

In a class of this embodiment, a convex plate is arranged at the middle bottom of the radial recess.

In a class of this embodiment, each magnetic induction block is arranged with a through hole to facilitate mounting.

In a class of this embodiment, a line connecting the center of the central axial bore and the center of circle is a central boundary line of the circular-arc line of the outer side surface.

Advantages of the invention are summarized below:
1) the iron core comprises an annular ring having a central axial bore and a plurality of magnetic induction blocks protruding outwards from outer side of the annular ring, between two adjacent magnetic induction blocks form a radial recess for mounting the permanent magnets, the magnetic induction blocks at both sides of the opening of the radial recess protrude with a hook block, the section of the outer side surface of the magnetic induction blocks is an circular-arc line and the outer side employs a point with a distance deviating from the center of the central axial bore as the center of circle. Such structure is helpful to reduce magnetic leakage of the rotor core, lower cogging torque ripple, and achieve a big counter-electromotive force constant and smooth waveform of the counter-electromotive force. Therefore, the motor's performance has been improved and losses have been reduced;
2) the distance deviating from the center of the central axial bore is 5-20 mm, the maximum external diameter of the iron core is 80-90 mm and the number of the magnetic induction blocks is 10. It further helps to reduce the magnetic leakage of the rotor core due to the optimized dimension parameters; and
3) the distance between the two hook blocks arranged at the opening of the same radial recess is 3.5-5 mm and a convex plate is arranged at the middle bottom of the radial recess, thus it can further reduce magnetic leakage of the rotor core.

### BRIEF DESCRIPTION OF THE DRAWINGS

FIG. 1 is a schematic diagram of a permanent magnet rotor in the prior art;

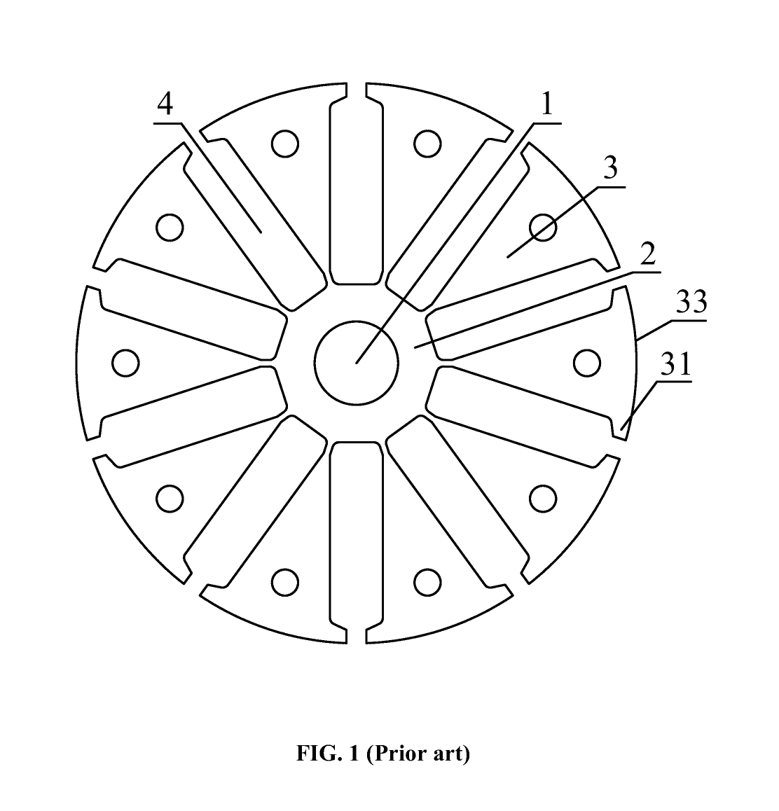

FIG. 2 is a schematic diagram of a permanent magnet rotor according to one embodiment of the invention;

FIG. 3 is a schematic diagram of a iron core according to one embodiment of the invention; and

FIG. 4 is a design principle diagram of a permanent magnet rotor according to one embodiment of the invention.

### DETAILED DESCRIPTION OF THE EMBODIMENTS

The invention is explained in further detail below with reference to the accompanying drawings and embodiments.

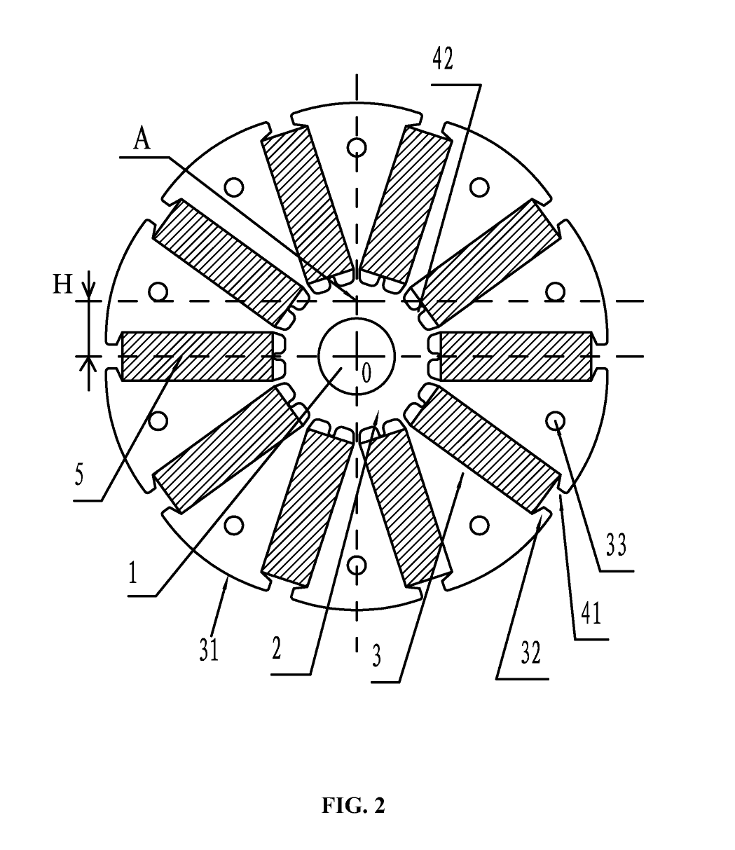

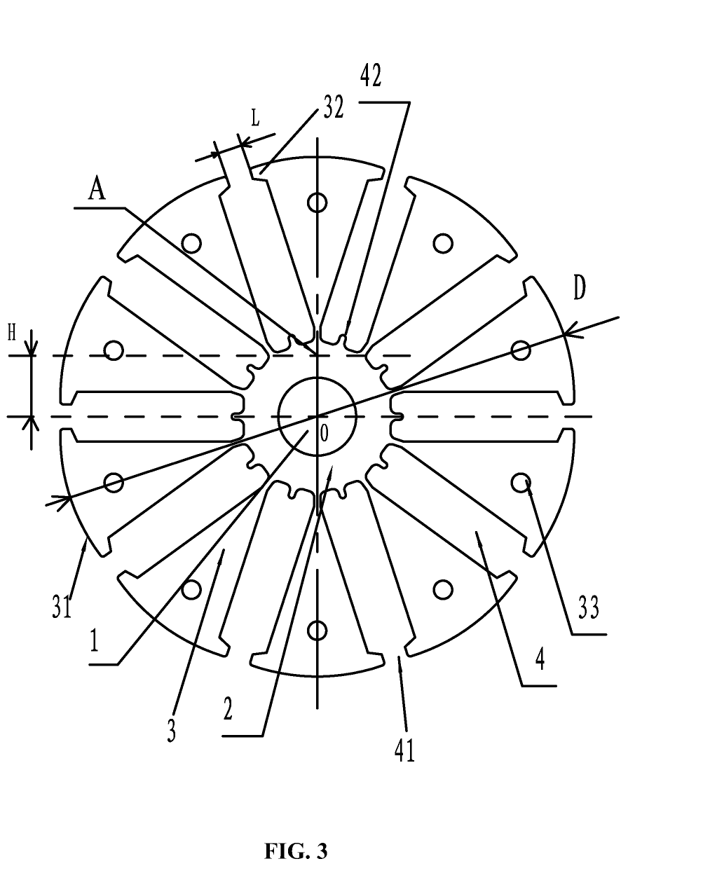

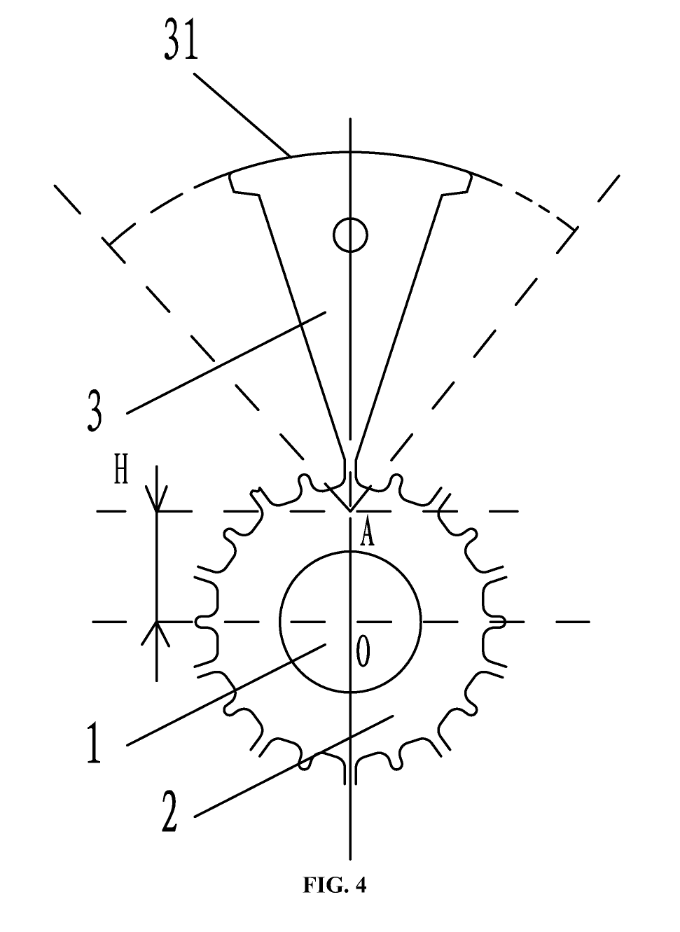

As shown in FIGS. 2, 3, and 4, a permanent magnet rotor of a motor comprises an iron core and a permanent magnet 5. The iron core comprises an annular ring 2 having a central axial bore 1 and a plurality of magnetic induction blocks 3 protruding outwards from an outer side of the annular ring 2. Between two adjacent magnetic induction blocks 3 form a radial recess 4 for mounting a permanent magnet 6. The magnetic induction blocks 3 at both sides of an opening 41 of the radial recess 4 protrude with a hook block 32. The section of the outer side surface 31 of the magnetic induction blocks 3 is an circular-arc line and the outer side surface 31 employs a point A with a distance H deviating from the center O of the central axial bore 1 as a center of circle. The distance H deviating from the center O of the central axial bore 1 is 5-20 mm The maximum external diameter D of the iron core is 80-90 mm and the number of the magnetic induction blocks is 10, a distance L between the two hook blocks 32 arranged at the opening 41 of the same radial recess 4 is 3.5-5 mm. A convex plate 42 is arranged at the middle bottom of the radial recess 4. A line connecting the center O of the central axial bore 1 and the center of circle A is a central boundary line of the circular-arc line of the outer side surface 31.

In accordance with the invention, the section of the outer side surface 31 of the magnetic induction blocks 3 is an circular-arc line and the outer side surface 31 employs a point A with a distance H deviating from the center O of the central axial bore 1 as the center of circle. The distance H deviating from the center O of the central axial bore 1 is 5-20 mm. Such structure changes the shape of the outer side surface 31 of the magnetic induction blocks 3, thus it has a simple structure, low magnetic leakage and torque ripple, big counter-electromotive force constant, and smooth waveform of counter-electromotive force. Thus, the motor's performance has been improved and losses have been reduced. The permanent magnet rotor of the invention is mainly used for air-conditioned motors.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A permanent magnet rotor of a motor, comprising an iron core and a permanent magnet, wherein
the iron core comprises an annular ring having a central axial bore and a plurality of magnetic induction blocks protruding outwards from an outer side of the annular ring;
between two adjacent magnetic induction blocks form a radial recess for mounting the permanent magnets;
the magnetic induction blocks at both sides of an opening of the radial recess protrude with a hook block; and
the section of an outer side surface of the magnetic induction blocks is an circular-arc line and the outer side surface employs a point with a distance deviating from the center of the central axial bore as a center of circle.

2. The permanent magnet rotor of claim 1, wherein the distance deviating from the center of the central axial bore is 5-20 mm.

3. The permanent magnet rotor of claim 1, wherein the maximum external diameter of the iron core is 80-90 mm and the number of the magnetic induction blocks is 10.

4. The permanent magnet rotor of claim 1, wherein a distance between two hook blocks arranged at the opening of the same radial recess is 3.5-5 mm.

5. The permanent magnet rotor of claim 2, wherein a distance between two hook blocks arranged at the opening of the same radial recess is 3.5-5 mm.

6. The permanent magnet rotor of claim 3, wherein a distance between two hook blocks arranged at the opening of the same radial recess is 3.5-5 mm.

7. The permanent magnet rotor of claim 4, wherein a convex plate is arranged at the middle bottom of the radial recess.

8. The permanent magnet rotor of claim 5, wherein a convex plate is arranged at the middle bottom of the radial recess.

9. The permanent magnet rotor of claim 6, wherein a convex plate is arranged at the middle bottom of the radial recess.

10. The permanent magnet rotor of claim 7, wherein each magnetic induction block is arranged with a through hole.

11. The permanent magnet rotor of claim 8, wherein each magnetic induction block is arranged with a through hole.

12. The permanent magnet rotor of claim 9, wherein each magnetic induction block is arranged with a through hole.

13. The permanent magnet rotor of claim 1, wherein a line connecting the center of the central axial bore and the center of circle is a central boundary line of the circular-arc line of the outer side surface.
